(19) United States
(12) Patent Application Publication
(10) Pub. No.: US 2024/0421328 A1
(43) Pub. Date: Dec. 19, 2024

(54) POWER GENERATION CELL AND FUEL CELL STACK

(71) Applicant: HONDA MOTOR CO., LTD., MINATO-KU, TOKYO (JP)

(72) Inventors: Satoshi OYAMA, WAKO-SHI, SAITAMA-KEN (JP); Takuro OKUBO, WAKO-SHI, SAITAMA-KEN (JP); Yukihito TANAKA, WAKO-SHI, SAITAMA-KEN (JP); Fumiya ARAI, WAKO-SHI, SAITAMA-KEN (JP); Keisuke ANDO, WAKO-SHI, SAITAMA (JP); Natsumi IIZUKA, WAKO-SHI, SAITAMA-KEN (JP); Yutaka EBATO, WAKO-SHI, SAITAMA-KEN (JP)

(21) Appl. No.: 18/637,678

(22) Filed: Apr. 17, 2024

(30) Foreign Application Priority Data
Apr. 19, 2023 (CN) 202310423055.2

(51) Int. Cl. H01M 8/0276; H01M 8/0206; H01M 8/0258; H01M 8/2465

(52) U.S. Cl. CPC H01M 8/0276; H01M 8/0206; H01M 8/0258; H01M 8/2465

(57) ABSTRACT

A power generation cell of a fuel cell stack is equipped with a tunnel part that connects a coolant supply passage and a coolant flow field to each other. The tunnel part includes a first protrusion protruding from the first metal separator toward the resin frame member, and a first placement portion including a first seal placement surface on which the first resin seal member is disposed. The first seal placement surface is positioned in an opposite direction, with respect to the resin frame member, compared with a first end surface of the first protrusion in a protruding direction.

### CROSS-REFERENCE TO RELATED APPLICATIONS

This application is based upon and claims the benefit of priority from Chinese Patent Application No. 202310423055.2 filed on Apr. 19, 2023, the contents of which are incorporated herein by reference.

### BACKGROUND OF THE INVENTION

### Field of the Invention

The present invention relates to a power generation cell and a fuel cell stack.

### Description of the Related Art

In recent years, research and development have been conducted on fuel cell stacks that contribute to energy efficiency in order to ensure that more people have access to affordable, reliable, sustainable and modern energy.

For example, JP 2022-149486 A discloses a power generation cell including a membrane electrode assembly with a resin frame and metal separators disposed on both sides of the membrane electrode assembly with the resin frame. Each of the metal separators is provided with a seal portion for preventing leakage of a fluid that is an oxygen-containing gas, a fuel gas, or a coolant.

### SUMMARY OF THE INVENTION

There is a need for a power generation cell and a fuel cell stack that can effectively prevent fluid leakage while reducing manufacturing costs.

The present invention has the object of solving the aforementioned problem.

An aspect of the present invention is a power generation cell equipped with a resin-framed membrane electrode assembly including a membrane electrode assembly and a resin frame member, the membrane electrode assembly being provided with electrodes arranged on both sides of an electrolyte membrane, the resin frame member projecting outward from an outer peripheral portion of the membrane electrode assembly and surrounding the membrane electrode assembly, metal separators arranged on both sides of the resin-framed membrane electrode assembly, and resin seal members arranged between the resin frame member and the metal separators and configured to be elastically deformed, wherein each of the metal separators includes a fluid passage configured to allow a fluid, which is an oxygen-containing gas, a fuel gas, or a coolant, to flow in a thickness direction of the metal separators, a fluid flow field configured to allow the fluid in a surface direction of the metal separators, and a tunnel part configured to connect the fluid passage and the fluid flow field, and wherein the resin seal member is disposed in a direction intersecting a flow direction in which the fluid flows in an interior of the tunnel part, so as to straddle the tunnel part, and the tunnel part includes a protrusion protruding from each of the metal separators toward the resin frame member, a placement portion including a seal placement surface on which the resin seal member is disposed, and wherein the seal placement surface is positioned in an opposite direction, with respect to the resin frame member, compared with an end surface of the protrusion in a protruding direction.

Another aspect of the present invention is a fuel cell stack in which the above-mentioned power generation cell is provided in plural and stacked.

According to the present invention, the leakage of the fluid can be effectively prevented while reducing the manufacturing costs.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an exploded perspective view of a fuel cell stack according to an embodiment of the present invention;

FIG. 2 is a plan view of a first metal separator;

FIG. 3 is a plan view of the second metal separator;

FIG. 4 is a cross-sectional perspective explanatory diagram of a coolant inlet part;

FIG. 5 is a cross-sectional view taken along line V-V of FIG. 4;

FIG. 6 is a cross-sectional perspective explanatory diagram of the coolant inlet part; and

FIG. 7 is a cross-sectional view taken along line VII-VII of FIG. 6.

### DETAILED DESCRIPTION OF THE INVENTION

A power generation cell 10 and a fuel cell stack 12 according to an embodiment of the present invention will be described below with reference to the drawings. The fuel cell stack 12 according to the present embodiment, for example, is mounted in a non-illustrated vehicle. The use of the fuel cell stack 12 is not particularly limited.

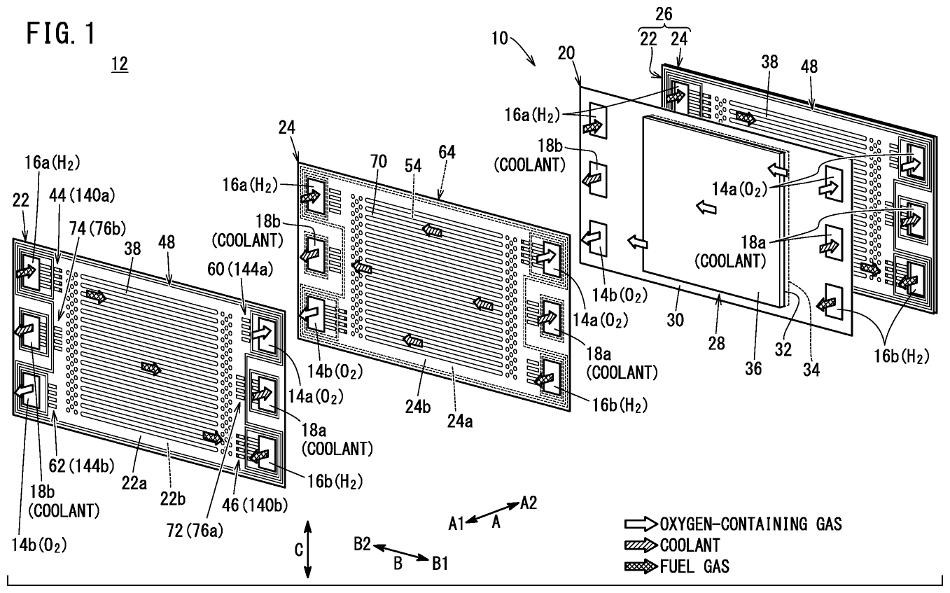

As shown in FIG. 1, the fuel cell stack 12 is formed by stacking a plurality of power generation cells 10 on each other in a direction of arrow A. A compressive load (fastening load) in the stacking direction (the direction of arrow A) is applied to the power generation cell 10 by a fastening member (not shown) or the like.

The power generation cell 10 has a laterally elongated rectangular shape. The shape of the power generation cell 10 is not particularly limited, and may be formed in a vertically elongated rectangular shape or a square shape, for example. The power generation cell 10 generates power by electrochemical reactions between an oxygen-containing gas as one of the reactant gases and a fuel gas as another of the reactant gases. The fuel gas is, for example, a hydrogen-containing gas. A coolant for cooling the power generation cell 10 flows through the power generation cell 10. The coolant is, for example, pure water, ethylene glycol, oil, or the like.

An oxygen-containing gas supply passage 14a, an oxygen-containing gas discharge passage 14b, a fuel gas supply passage 16a, a fuel gas discharge passage 16b, a coolant supply passage 18a and a coolant discharge passage 18b are formed to penetrate each of the power generation cells 10 in the stacking direction (the direction indicated by arrow A).

One marginal end portion of a longer side (a marginal end portion in the direction indicated by arrow B1) of the power generation cell 10 is provided with the oxygen-containing gas supply passage 14a, the coolant supply passage 18a, and the fuel gas discharge passage 16b. The oxygen-containing gas supply passage 14a, the coolant supply passage 18a, and the fuel gas discharge passage 16b are arranged on a shorter side of the power generation cell 10 (a direction of arrow C).

The oxygen-containing gas flows through the oxygen-containing gas supply passage 14a in the direction indicated by arrow A2. The coolant flows through the coolant supply passage 18a in the direction indicated by arrow A2. The fuel gas flows through the fuel gas discharge passage 16b in the direction indicated by arrow A1.

The other marginal end portion of the longer side (the other marginal end portion in the direction indicated by arrow B2) of the power generation cell 10 is provided with the fuel gas supply passage 16a, the coolant discharge passage 18b, and the oxygen-containing gas discharge passage 14b. The fuel gas supply passage 16a, the coolant discharge passage 18b, and the oxygen-containing gas discharge passage 14b are arranged in the direction of arrow C.

The fuel gas flows through the fuel gas supply passage 16a in the direction indicated by arrow A2. The coolant flows through the coolant discharge passage 18b in the direction indicated by arrow A1. The oxygen-containing gas flows through the oxygen-containing gas discharge passage 14b in the direction indicated by arrow A1.

The oxygen-containing gas supply passage 14a, oxygen-containing gas discharge passage 14b, fuel gas supply passage 16a, fuel gas discharge passage 16b, coolant supply passage 18a, and coolant discharge passage 18b are fluid passages for allowing a fluid, which is an oxygen-containing gas, a fuel gas, or a coolant, to flow in the direction of arrow A. The positions, shapes, and sizes of the oxygen-containing gas supply passage 14a, the oxygen-containing gas discharge passage 14b, the fuel gas supply passage 16a, the fuel gas discharge passage 16b, the coolant supply passage 18a, and the coolant discharge passage 18b may be set appropriately depending on required specifications.

The power generation cell 10 includes a resin-framed membrane electrode assembly 20, a first metal separator 22, and a second metal separator 24. The first metal separator 22 is disposed on one surface (the surface facing in the direction of arrow A2) of the resin-framed membrane electrode assembly 20. The second metal separator 24 is disposed on another surface (the surface facing in the direction of arrow A1) of the resin-framed membrane electrode assembly 20. The first metal separator 22 and the second metal separator 24 sandwich the resin-framed membrane electrode assembly 20 in the direction of arrow A.

A joined separator 26 is formed by joining the first metal separator 22 and the second metal separator 24 to each other. The joined separator 26 is provided with a joining line (not shown) for joining the first metal separator 22 and the second metal separator 24 to each other in an air-tight and liquid-tight manner. The joining line surrounds the outer marginal portion of the joined separator 26. The joining line surrounds each of the fluid passages (the oxygen-containing gas supply passage 14a and the like). The resin-framed membrane electrode assemblies 20 and the joined separators 26 are alternately laminated in the direction of arrow A.

The resin-framed membrane electrode assembly 20 includes a membrane electrode assembly (MEA) 28 and a resin frame member 30. The membrane electrode assembly 28 includes an electrolyte membrane 32, a first electrode 34, and a second electrode 36. The electrolyte membrane 32, for example, is a solid polymer electrolyte membrane (a cation ion exchange membrane). The solid polymer electrolyte membrane is formed by impregnating a thin membrane of perfluorosulfonic acid with water, for example. A fluorine based electrolyte may be used as the electrolyte membrane 32. Alternatively, an HC (hydrocarbon) based electrolyte may be used as the electrolyte membrane 32. The electrolyte membrane 32 is sandwiched between the first electrode 34 and the second electrode 36.

The first electrode 34 is an anode provided on one surface (a surface in the direction of arrow A2) of the electrolyte membrane 32. The second electrode 36 is a cathode provided on another surface (a surface in the direction of arrow A1) of the electrolyte membrane 32. The first metal separator 22 is disposed so as to face the first electrode 34. The second metal separator 24 is disposed so as to face the second electrode 36.

The first electrode 34 includes a first electrode catalyst layer and a first gas diffusion layer. The first electrode catalyst layer is joined to the one surface of the electrolyte membrane 32. The first gas diffusion layer is laminated on the first electrode catalyst layer. The second electrode 36 includes a second electrode catalyst layer and a second gas diffusion layer. The second electrode catalyst layer is joined to the other surface of the electrolyte membrane 32. The second gas diffusion layer is laminated on the second electrode catalyst layer. Each of the first gas diffusion layer and the second gas diffusion layer is formed of carbon paper, carbon cloth, or the like.

The fuel gas flowing through the fuel gas supply passage 16a is guided to flow between the first metal separator 22 and the resin-framed membrane electrode assembly 20, and is supplied to the first electrode 34. The oxygen-containing gas flowing through the oxygen-containing gas supply passage 14a is guided to flow between the second metal separator 24 and the resin-framed membrane electrode assembly 20, and is supplied to the second electrode 36. The power generation cell 10 generates power by the fuel gas supplied to the first electrode 34 and the oxygen-containing gas supplied to the second electrode 36.

The fuel gas flowing between the first metal separator 22 and the resin-framed membrane electrode assembly 20 is guided to the fuel gas discharge passage 16b. The oxygen-containing gas flowing between the second metal separator 24 and the resin-framed membrane electrode assembly 20 is guided to the oxygen-containing gas discharge passage 14b. The coolant supplied to the coolant supply passage 18a flows between the first metal separator 22 and the second metal separator 24, and then flows through the coolant discharge passage 18b.

The resin frame member 30 is a frame-shaped sheet surrounding an outer peripheral portion of the membrane electrode assembly 28. The inner peripheral end portion of the resin frame member 30 is sandwiched by the outer peripheral portion of the membrane electrode assembly 28. The resin frame member 30 has electrical insulation properties.

Examples of materials of the resin frame member 30 include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), and modified polyolefin.

One marginal end portion of the resin frame member 30 (a marginal end portion in the direction indicated by arrow B1) is provided with the oxygen-containing gas supply passage 14a, the coolant supply passage 18a, and the fuel gas discharge passage 16b. Another marginal end portion (a marginal end portion in the direction indicated by arrow B2) of the resin frame member 30 is provided with the fuel gas supply passage 16a, the coolant discharge passage 18b, and the oxygen-containing gas discharge passage 14b.

The resin frame member 30 of the resin-framed membrane electrode assembly 20 may be formed by projecting the electrolyte membrane 32 outward from the outer peripheries of the first electrode 34 and the second electrode 36.

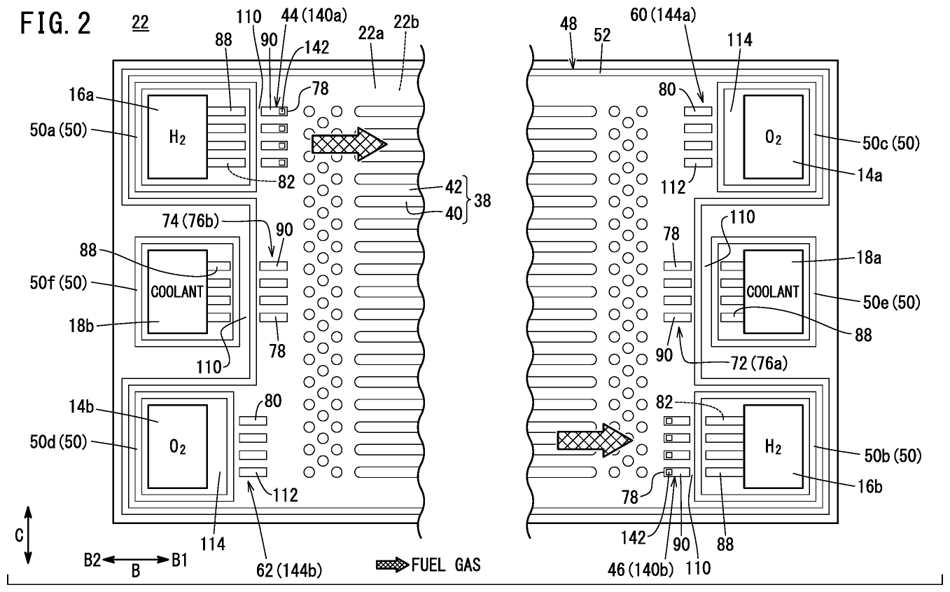

As shown in FIGS. 1 and 2, the first metal separator 22 is formed in a sheet shape. The first metal separator 22 is, for example, a thin metal sheet such as a steel sheet, a stainless steel sheet, or an aluminum sheet. The first metal separator 22 may be subjected to an anti-corrosion treatment. The first metal separator 22 is formed in a rectangular shape. One marginal end portion (a marginal end portion in the direction indicated by arrow B1) of the first metal separator 22 is provided with the oxygen-containing gas supply passage 14a, the coolant supply passage 18a, and the fuel gas discharge passage 16b. Another marginal end portion (a marginal end portion in the direction indicated by arrow B2) of the first metal separator 22 is provided with the fuel gas supply passage 16a, the coolant discharge passage 18b, and the oxygen-containing gas discharge passage 14b. The first metal separator 22 is formed by pressing a metal sheet.

The first metal separator 22 includes a first front surface 22a facing the resin-framed membrane electrode assembly 20, and a first back surface 22b facing the second metal separator 24 of the power generation cell 10 adjacent to the first metal separator 22.

As shown in FIG. 2, a first gas flow field (fluid flow field) 38 is formed on the first front surface 22a of the first metal separator 22. The first gas flow field 38 is a fuel gas flow field for allowing the fuel gas to flow along the first electrode 34. The first gas flow field 38 includes a plurality of first flow field ridges 40 and a plurality of first flow field grooves 42. The first flow field ridges 40 and the first flow field grooves 42 are alternately provided in the direction of arrow C. Each of the first flow field ridges 40 and the first flow field grooves 42 extends linearly in the direction of arrow B. Each of the first flow field ridges 40 and the first flow field grooves 42 may extend in a wave form in the direction of arrow B.

The first gas flow field 38 is connected to the fuel gas supply passage 16a through a fuel gas inlet part 44. The first gas flow field 38 is connected to the fuel gas discharge passage 16b through a fuel gas outlet part 46. The details of the fuel gas inlet part 44 and the fuel gas outlet part 46 will be described later.

A first resin seal member 48 is disposed between the first metal separator 22 and the resin frame member 30. The first resin seal member 48 is fixed to the first front surface 22a of the first metal separator 22. Specifically, the first resin seal member 48 is formed by applying a liquid resin material to the first front surface 22a by screen printing, for example. The first resin seal member 48 may be formed by applying a liquid resin material to the first front surface 22a with a dispenser. The first resin seal member 48 may be formed by bonding a solid resin material which is formed in a predetermined shape in advance, to the first front surface 22a with an adhesive or the like. The first resin seal member 48 may be fixed to the resin frame member 30.

The first resin seal member 48 prevents the oxygen-containing gas, the fuel gas, or a fluid serving as the coolant from leaking between the resin-framed membrane electrode assembly 20 and the first metal separator 22. The first resin seal member 48 is made of a rubber material. Examples of the material of the first resin seal member 48 include EPDM (ethylene-propylene rubber), NBR, a silicone rubber, a fluorosilicone rubber, a butyl rubber, a natural rubber, a styrene rubber, a chloroprene rubber, or an acrylic rubber. The first resin seal member 48 has a quadrangular cross section.

The first resin seal member 48 includes a plurality of first passage seals 50a to 50f and a first flow field seal 52. The first passage seal 50a surrounds the fuel gas supply passage 16a. The first passage seal 50b surrounds the fuel gas discharge passage 16b. The first passage seal 50c surrounds the oxygen-containing gas supply passage 14a. The first passage seal 50d surrounds the oxygen-containing gas discharge passage 14b. The first passage seal 50e surrounds the coolant supply passage 18a. The first passage seal 50f surrounds the coolant discharge passage 18b. Hereinafter, the plurality of first passage seals 50a to 50f may be simply referred to as “first passage seals 50”.

The first flow field seal 52 surrounds the first passage seals 50a to 50d and the first gas flow field 38. The first passage seals 50e and 50f are located outside the first flow field seal 52.

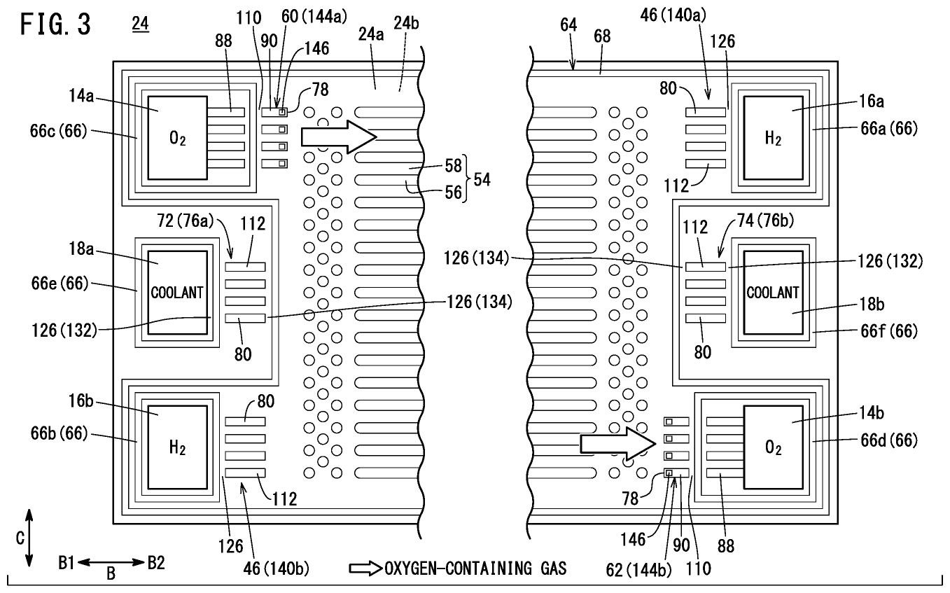

As shown in FIGS. 1 and 3, the second metal separator 24 is formed in a sheet shape. The second metal separator 24 is, for example, a thin metal sheet such as a steel sheet, a stainless steel sheet, or an aluminum sheet. The second metal separator 24 may be subjected to an anticorrosion treatment. The second metal separator 24 is formed in a rectangular shape. The one marginal end portion (the marginal end portion in the direction indicated by arrow B1) of the second metal separator 24 is provided with the oxygen-containing gas supply passage 14a, the coolant supply passage 18a, and the fuel gas discharge passage 16b. The other marginal end portion (the marginal end portion in the direction indicated by arrow B2) of the second metal separator 24 is provided with the fuel gas supply passage 16a, the coolant discharge passage 18b, and the oxygen-containing gas discharge passage 14b. The second metal separator 24 is formed by pressing a metal sheet.

The second metal separator 24 includes a second front surface 24a facing the resin-framed membrane electrode assembly 20, and a second back surface 24b facing the first metal separator 22 of the adjacent power generation cell 10.

As shown in FIG. 3, a second gas flow field (fluid flow field) 54 is formed on the second front surface 24a of the second metal separator 24. The second gas flow field 54 is an oxygen-containing gas flow field for allowing the oxygen-containing gas to flow along the second electrode 36. The second gas flow field 54 includes a plurality of second flow field ridges 56 and a plurality of second flow field grooves 58. The second flow field ridges 56 and the second flow field grooves 58 are alternately provided in the direction of arrow C. Each of the second flow field ridges 56 and the second flow field grooves 58 extends linearly in the direction of arrow B. Each of the second flow field ridges 56 and the second flow field grooves 58 may extend in a wave form in the direction of arrow B.

The second gas flow field 54 is connected to the oxygen-containing gas supply passage 14a through an oxygen-containing gas inlet part 60. The second gas flow field 54 is connected to the oxygen-containing gas discharge passage 14b through an oxygen-containing gas outlet part 62. The details of the oxygen-containing gas inlet part 60 and the oxygen-containing gas outlet part 62 will be described later.

A second resin seal member 64 is disposed between the second metal separator 24 and the resin frame member 30. The second resin seal member 64 is fixed to the second front surface 24a of the second metal separator 24. Specifically, the second resin seal member 64 is formed by applying a liquid resin material to the second front surface 24a by screen printing, for example. The second resin seal member 64 may be formed by applying a liquid resin material to the second front surface 24a with a dispenser. The second resin seal member 64 may be formed by bonding a solid resin material which is formed in a predetermined shape in advance, to the second front surface 24a with an adhesive or the like. The second resin seal member 64 may be fixed to the resin frame member 30.

The second resin seal member 64 prevents the oxygen-containing gas, the fuel gas, or a fluid serving as the coolant from leaking between the resin-framed membrane electrode assembly 20 and the second metal separator 24. The second resin seal member 64 is made of a rubber material. Examples of the constituent material of the second resin seal member 64 include the same materials as those of the first resin seal member 48 described above. The second resin seal member 64 has a quadrangular cross section.

The second resin seal member 64 includes a plurality of second passage seals 66a to 66f and a second flow field seal 68. The second passage seal 66a surrounds the fuel gas supply passage 16a. The second passage seal 66b surrounds the fuel gas discharge passage 16b. The second passage seal 66c surrounds the oxygen-containing gas supply passage 14a. The second passage seal 66d surrounds the oxygen-containing gas discharge passage 14b. The second passage seal 66e surrounds the coolant supply passage 18a. The second passage seal 66f surrounds the coolant discharge passage 18b. Hereinafter, the plurality of second passage seals 66a to 66f may be simply referred to as “second passage seals 66”.

The second flow field seal 68 surrounds the second passage seals 66a to 66d and the second gas flow field 54. The second passage seals 66e and 66f are located outside the second flow field seal 68.

As shown in FIG. 1, a coolant flow field (fluid flow field) 70 is formed between the first back surface 22b of the first metal separator 22 and the second back surface 24b of the second metal separator 24. The coolant flow field 70 is formed on the back surface of the first gas flow field 38 and the back surface of the second gas flow field 54.

The coolant flow field 70 is connected to the coolant supply passage 18a through a coolant inlet part 72. The coolant flow field 70 is connected to the coolant discharge passage 18b through a coolant outlet part 74.

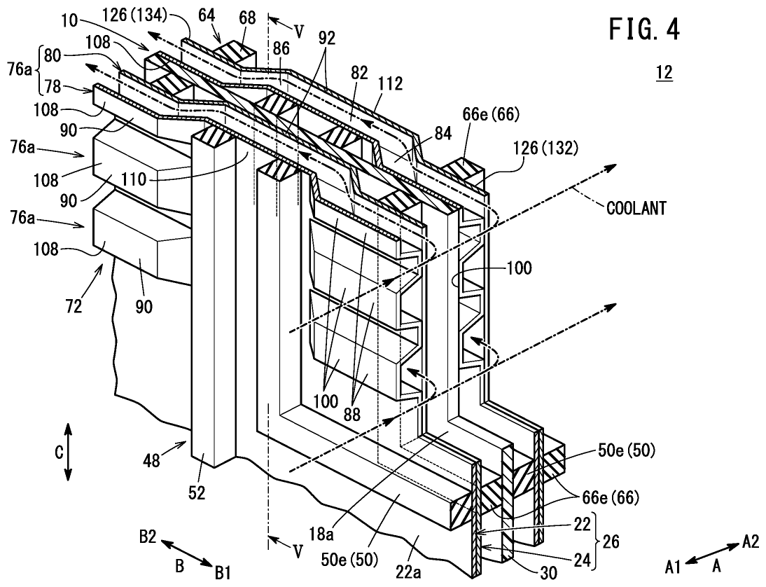

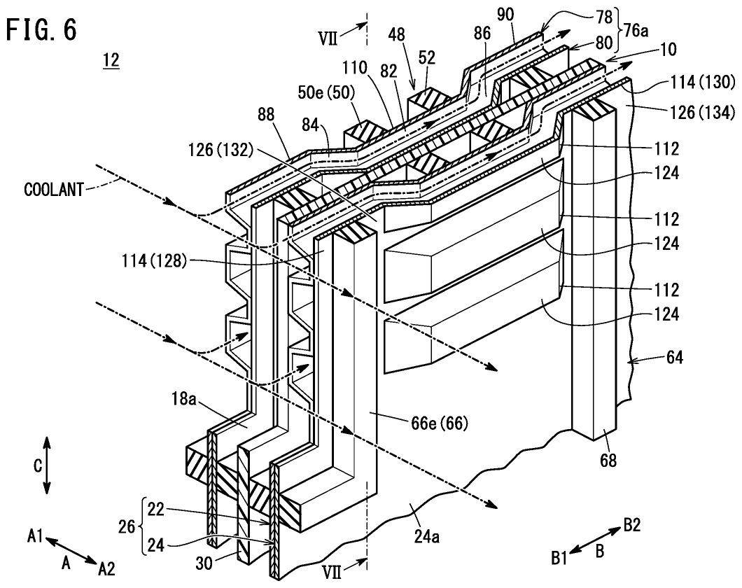

As shown in FIGS. 4 to 7, the coolant inlet part 72 includes a plurality of tunnel parts 76a. As shown in FIGS. 4 and 6, the tunnel parts 76a extend linearly in the direction of arrow B. The plurality of tunnel parts 76a are arranged at intervals in the direction of arrow C. In the present embodiment, the coolant inlet part 72 has the four tunnel parts 76a. The number of tunnel parts 76a can be set as appropriate, and may be one or more (other than four).

Each of the tunnel parts 76a includes a first tunnel wall 78 and a second tunnel wall 80. The first tunnel wall 78 is provided in the first metal separator 22. The second tunnel wall 80 is provided in the second metal separator 24. A connection channel 82 through which the coolant flows in the direction of arrow B2 is formed between the first tunnel wall 78 and the second tunnel wall 80. The connection channel 82 has a first bent portion 84 and a second bent portion 86. The first bent portion 84 is inclined in the direction of arrow A2 with respect to the direction of arrow B2. The second bent portion 86 is inclined in the direction of arrow A1 with respect to the direction of arrow B2.

As shown in FIG. 4, each of the first tunnel walls 78 includes a first protrusion 88, a second protrusion 90, and a first placement portion 92. Each of the first protrusions 88 and the second protrusions 90 is integrally provided on the first metal separator 22 by pressing a metal sheet. The first protrusion 88 extends from the coolant supply passage 18a toward the coolant flow field 70 (in the direction of arrow B2) (see FIG. 2). The first protrusion 88 protrudes from the first front surface 22a of the first metal separator 22 toward the resin frame member 30 (in the direction of arrow A1).

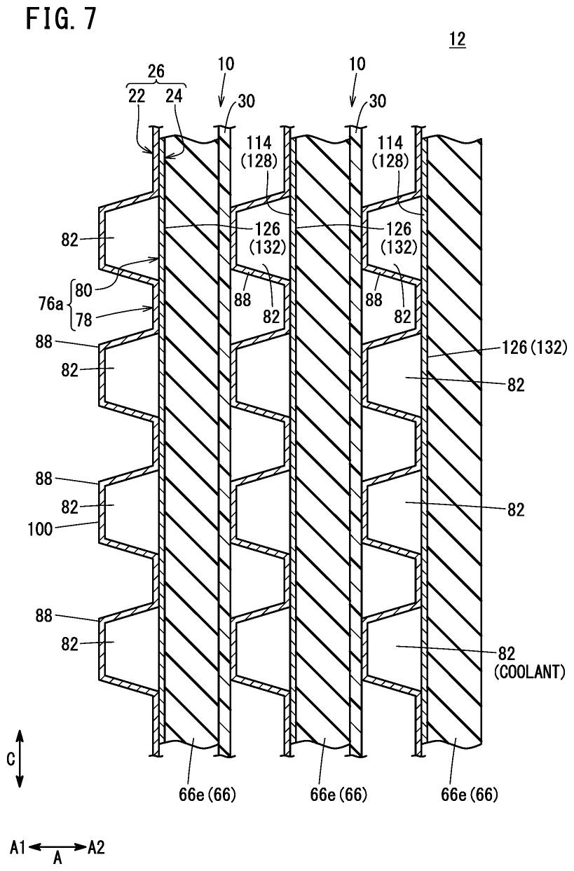

As shown in FIGS. 4 and 7, the first protrusion 88 is formed in a trapezoidal shape, in a cross-section viewed in a direction perpendicular to the stacking direction of the power generation cell 10. The internal space of the first protrusion 88 forms a connection channel 82. The end portion of the first protrusion 88 in the direction of arrow B1 is open at the coolant supply passage 18a. A first end surface 100 of the first protrusion 88 in a protruding direction is in contact with or close to the adjacent resin frame member 30 adjacent to the first metal separator 22.

As shown in FIG. 4, the second protrusion 90 is located at a predetermined distance from the first protrusion 88 in the direction of arrow B2. The second protrusion 90 is formed in a trapezoidal shape, in a cross-section viewed in a direction perpendicular to the stacking direction of the power generation cell 10. The internal space of the second protrusion 90 forms the connection channel 82. A second end surface 108 of the second protrusion 90 in a protruding direction is in contact with or close to the resin frame member 30 adjacent to the first metal separator 22.

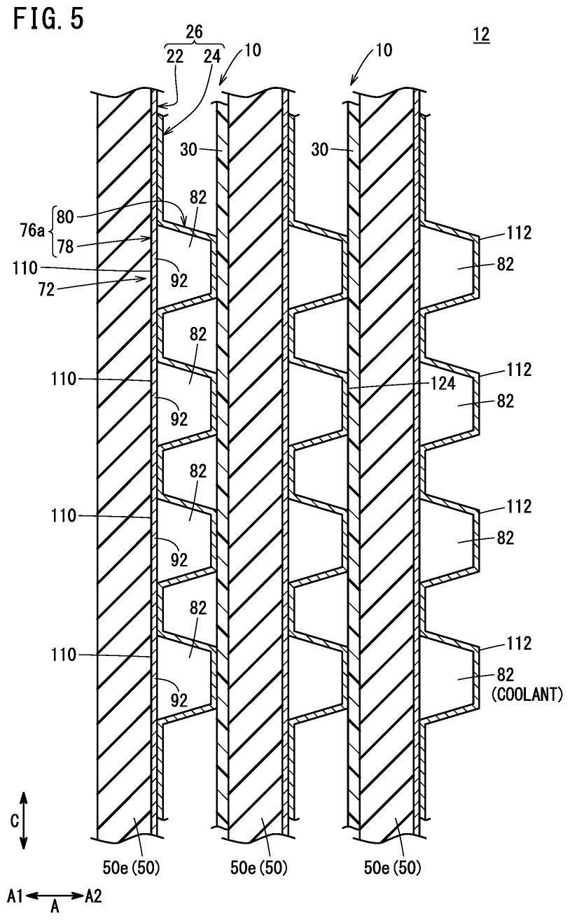

The first placement portion 92 connects the end portion of the first protrusion 88 in the direction of arrow B2 and the end portion of the second protrusion 90 in the direction of arrow B1 to each other. The first placement portion 92 has a first seal placement surface 110 on which the first resin seal member 48 is disposed. The first seal placement surface 110 faces the resin frame member 30 (in the direction of arrow A1). The first passage seal 50e and the first flow field seal 52 are arranged on the first seal placement surface 110. The first passage seal 50e and the first flow field seal 52 are arranged in a direction (the direction of arrow C) intersecting a direction in which the coolant flows in the interior of the tunnel parts 76a (the connection channels 82), so as to straddle the tunnel parts 76a (see FIGS. 4 and 5).

The first seal placement surface 110 is positioned in the opposite direction with respect to the resin frame member 30 (the direction of arrow A2), compared with the first end surface 100 and the second end surface 108. The first seal placement surface 110 is formed flat and is continuous with the first front surface 22a of the first metal separator 22 in a flush manner.

As shown in FIG. 6, each of the second tunnel walls 80 includes a third protrusion 112 and second placement portions 114. Each of the third protrusions 112 is integrally provided on the second metal separator 24 by pressing a metal sheet. The third protrusion 112 extends in the direction of arrow B. The third protrusion 112 protrudes from the second front surface 24a of the second metal separator 24 toward the resin frame member 30 (in the direction of arrow A2).

As shown in FIGS. 5 and 6, the third protrusion 112 is formed in a trapezoidal shape, in a cross-section viewed in a direction perpendicular to the stacking direction of the power generation cell 10. The third protrusion 112 and the first placement portion 92 face each other in a state where they are separated from each other. The internal space of the third protrusion 112 forms the connection channel 82. The internal space of the third protrusion 112 is connected to the internal space of the first protrusion 88 and the internal space of the second protrusion 90. A third end surface 124 of the third protrusion 112 in a protruding direction is in contact with or close to the resin frame member 30 adjacent to the second metal separator 24.

As shown in FIG. 6, the second placement portion 114 has a second seal placement surface 126 on which the second resin seal member 64 is disposed. The second placement portion 114 includes an outer placement portion 128 and an inner placement portion 130. The outer placement portion 128 is connected to an end portion of the third protrusion 112 in the direction of arrow B1. The outer placement portion 128 and the first protrusion 88 face each other in a state where they are separated from each other. The outer placement portion 128 has an outer seal placement surface 132 on which the second passage seal 66e is disposed. The outer seal placement surface 132 faces the resin frame member 30 (in the direction of arrow A2). The second passage seal 66e is disposed in a direction (the direction of arrow C) intersecting a direction in which the coolant flows in the interior of the tunnel parts 76a (the connection channels 82), so as to straddle the tunnel parts 76a.

The outer seal placement surface 132 is positioned in the opposite direction with respect to the resin frame member 30 (the direction of arrow A1), compared with the third end surface 124. The outer seal placement surface 132 is positioned in the direction (the direction of arrow B1) relative to the first seal placement surface 110. The outer seal placement surface 132 is formed flat and is continuous with the second front surface 24a of the second metal separator 24 in a flush manner.

The inner placement portion 130 is connected to an end portion of the third protrusion 112 in the direction of arrow B2. The inner placement portion 130 and the second protrusion 90 face each other in a state where they are separated from each other. The inner placement portion 130 has an inner seal placement surface 134 on which the second flow field seal 68 is arranged. The second flow field seal 68 is disposed in a direction (the direction of arrow C) intersecting a direction in which the coolant flows in the interior of the tunnel parts 76a (the connection channels 82), so as to straddle the tunnel parts 76a.

The inner seal placement surface 134 faces the resin frame member 30 (in the direction of arrow A2). The inner seal placement surface 134 is positioned in the opposite direction with respect to the resin frame member 30 (the direction of arrow A1), compared with the third end surface 124. The inner seal placement surface 134 is positioned inward of the first seal placement surface 110. The inner seal placement surface 134 is continuous with the second front surface 24a of the second metal separator 24 in a flush manner. The first seal placement surface 110 and the second seal placement surface 126 (the outer seal placement surface 132 and the inner seal placement surface 134) are shifted (or in offset positions) in a direction (the direction of arrow B) in which the coolant flows in the interior of the tunnel part 76a (the connection channel 82).

As shown in FIGS. 2 and 3, the coolant outlet part 74 includes a plurality of tunnel parts 76b. Each of the tunnel parts 76b of the coolant outlet part 74 is configured in the same manner as the tunnel parts 76a of the coolant inlet part 72. In the tunnel parts 76b of the coolant outlet part 74, the same constituent elements as those of the tunnel parts 76a of the coolant inlet part 72 are designated by the same reference numerals, and detailed description thereof will be omitted. The same applies to the fuel gas inlet part 44, the fuel gas outlet part 46, the oxygen-containing gas inlet part 60, and the oxygen-containing gas outlet part 62, which will be described later.

In the tunnel parts 76b of the coolant outlet part 74, the first passage seal 50f and the first flow field seal 52 are disposed on the first seal placement surface 110 (see FIG. 2). In the tunnel parts 76b, the second passage seal 66f is disposed on the outer seal placement surface 132, and the second flow field seal 68 is disposed on the inner seal placement surface 134 (see FIG. 3).

The fuel gas inlet part 44 has a plurality of tunnel parts 140a. As shown in FIG. 2, in the tunnel parts 140a of the fuel gas inlet part 44, the first passage seal 50a is disposed on the first seal placement surface 110. In the second protrusion 90 of each of the tunnel parts 140a, an opening 142 for connecting the connection channel 82 of the tunnel part 140a with the first gas flow field 38 is formed. In the tunnel parts 140a, the second passage seal 66a is disposed on the second seal placement surface 126 positioned outward of the third protrusion 112 (see FIG. 3).

The fuel gas outlet part 46 has a plurality of tunnel parts 140b. Each of the tunnel parts 140b of the fuel gas outlet part 46 is configured in the same manner as the tunnel parts 140a of the fuel gas inlet part 44. In the tunnel parts 140b of the fuel gas outlet part 46, the first passage seal 50b is disposed on the first seal placement surface 110. In the tunnel parts 140b, the second passage seal 66b is disposed on the second seal placement surface 126 positioned outward of the third protrusion 112 (see FIG. 3).

As shown in FIGS. 2 and 3, the oxygen-containing gas inlet part 60 has a plurality of tunnel parts 144a. In each of the tunnel parts 144a of the oxygen-containing gas inlet part 60, the first tunnel wall 78 is provided in the second metal separator 24, and the second tunnel wall 80 is provided in the first metal separator 22. As shown in FIG. 3, in the tunnel parts 144a, the second passage seal 66c is disposed on the first seal placement surface 110. In the second protrusion 90 of each of the tunnel parts 144a, an opening 146 for connecting the connection channel 82 of the tunnel part 144a with the second gas flow field 54 is formed. In the tunnel parts 144a, the first passage seal 50c is disposed on the second seal placement surface 126 positioned outward of the third protrusion 112 (see FIG. 2).

The oxygen-containing gas outlet part 62 has a plurality of tunnel parts 144b. Each of the tunnel parts 144b of the oxygen-containing gas outlet part 62 is configured in the same manner as the tunnel parts 144a of the oxygen-containing gas inlet part 60. Around the tunnel parts 144b of the oxygen-containing gas outlet part 62, the second passage seal 66d is disposed on the first seal placement surface 110. Around the tunnel parts 144b, the first passage seal 50d is disposed on the second seal placement surface 126 positioned outward of the third protrusion 112 (see FIG. 2).

The present invention is not limited to the configuration described above. Around the tunnel parts 76a, 76b, 140a, 140b, 144a, and 144b, the first seal placement surface 110 may be positioned closer to the resin frame member 30 than the first front surface 22a of the first metal separator 22 is. Further, around the tunnel parts 76a, 76b, 140a, 140b, 144a, and 144b, the second seal placement surface 126 may be positioned closer to the resin frame member 30 than the second front surface 24a of the second metal separator 24 is. The power generation cell 10 may be configured such that the oxygen-containing gas flows through the first gas flow field 38 and the fuel gas flows through the second gas flow field 54.

With respect to the above disclosure, the following supplementary notes are disclosed.

### Supplementary Note 1

The power generation cell (10) is equipped with the resin-framed membrane electrode assembly (20) including the membrane electrode assembly (28) and the resin frame member (30), the membrane electrode assembly being provided with the electrodes (34, 36) arranged on both sides of the electrolyte membrane (32), the resin frame member projecting outward from the outer peripheral portion of the membrane electrode assembly and surrounding the membrane electrode assembly, the metal separators (22, 24) arranged on both sides of the resin-framed membrane electrode assembly, and the resin seal members (48, 64) arranged between the resin frame member and the metal separators and configured to be elastically deformed, wherein each of the metal separators includes the fluid passage (14a, 14b, 16a, 16b, 18a, 18b) configured to allow the fluid, which is the oxygen-containing gas, the fuel gas, or the coolant, to flow in the thickness direction of the metal separators, the fluid flow field (38, 54, 70) configured to allow the fluid in the surface direction of the metal separators, and the tunnel part (76a, 76b, 140a, 140b, 144a, 144b) configured to connect the fluid passage and the fluid flow field, and wherein the resin seal member is disposed in the direction intersecting the flow direction in which the fluid flows in the interior (82) of the tunnel part, so as to straddle the tunnel part, and the tunnel part includes the protrusion (88, 90, 112) protruding from each of the metal separators toward the resin frame member, the placement portion (92, 114) including the seal placement surface (110, 126) on which the resin seal member is disposed, and wherein the seal placement surface is positioned in the opposite direction, with respect to the resin frame member, compared with the end surface (100, 108, 124) of the protrusion in the protruding direction.

In accordance with such a configuration, a step (a dimension in the thickness direction of the metal separator) between the surface of the metal separator facing the resin frame portion and the seal arrangement surface can be reduced. Alternatively, a step can be eliminated between the surface of the metal separator and the seal placement surface. Thus, in a state where a fastening load is applied to the power generation cell, when viewed from the thickness direction of the metal separator, an excessive sealing surface pressure acting on a portion of the resin seal member that overlaps with the tunnel part can be suppressed. Therefore, it is not necessary to form the resin seal member in a complicated shape corresponding to the shape of the protrusion of the tunnel part. Therefore, the leakage of the fluid can be effectively prevented while reducing the manufacturing costs.

### Supplementary Note 2

In the power generation cell according to Supplementary Note 1, the resin seal member may include the first resin seal member (48) disposed on the first seal placement surface (110) serving as the seal placement surface of one of the metal separators, and the second resin seal member (64) disposed on the second seal placement surface (126) serving as the seal placement surface of the other of the metal separators, and wherein the first seal placement surface and the second seal placement surface may be shifted in the flow direction so as not to overlap with each other when viewed in the thickness direction.

In accordance with such a configuration, the first resin seal member and the second resin seal member do not overlap with each other at the position of the tunnel part when viewed from the thickness direction of the metal separator. Therefore, the dimension of the power generation cell in the thickness direction of the metal separator can be reduced.

### Supplementary Note 3

In the power generation cell according to Supplementary Note 2, the first resin seal member may include the first passage seal (50) surrounding the fluid passage, and the first flow field seal (52) surrounding the fluid flow field of the one of the metal separators, wherein the second resin seal member may include the second passage seal (66) surrounding the fluid passage, and the second flow field seal (68) surrounding the fluid flow field of the other of the metal separators, wherein the second seal placement surface may include the outer seal placement surface (132) positioned outward of the first seal placement surface, and the inner seal placement surface (134) positioned inward of the first seal placement surface, and wherein the second passage seal may be disposed on the outer seal placement surface, and the second flow field seal may be disposed on the inner seal placement surface.

In accordance with such a configuration, the space between the fluid flow field and the fluid passage of one of the metal separators can be doubly sealed by the first flow field seal and the first passage seal. Further, the space between the fluid flow field and the fluid passage of the other of the metal separators can be doubly sealed by the second flow field seal and the second passage seal.

### Supplementary Note 4

In the power generation cell according to any one of Supplementary Notes 1 to 3, wherein the seal placement surface may be formed flat and be flush with the front surface (22a, 24a) of the metal separator that faces the resin frame member.

In accordance with such a configuration, since no step is formed between the surface of the metal separator facing the resin frame member and the seal placement surface, the surface pressure of the resin seal member can be made substantially uniform in a state where a fastening load is applied to the power generation cell.

### Supplementary Note5

In the fuel cell stack (12), the power generation cell according to any one of Supplementary Notes 1 to 4 is provided in plural and stacked on each other.

The present invention is not limited to the above disclosure, and various modifications can be adopted therein without departing from the essence and gist of the present invention.

1. A power generation cell comprising:
a resin-framed membrane electrode assembly including a membrane electrode assembly and a resin frame member, the membrane electrode assembly being provided with electrodes arranged on both sides of an electrolyte membrane, the resin frame member projecting outward from an outer peripheral portion of the membrane electrode assembly and surrounding the membrane electrode assembly;
metal separators arranged on both sides of the resin-framed membrane electrode assembly; and
resin seal members arranged between the resin frame member and the metal separators and configured to be elastically deformed,
wherein each of the metal separators includes:
a fluid passage configured to allow a fluid, which is an oxygen-containing gas, a fuel gas, or a coolant, to flow in a thickness direction of the metal separators;
a fluid flow field configured to allow the fluid in a surface direction of the metal separators; and
a tunnel part configured to connect the fluid passage and the fluid flow field, and
wherein the resin seal member is disposed in a direction intersecting a flow direction in which the fluid flows in an interior of the tunnel part, so as to straddle the tunnel part, and
the tunnel part includes:
a protrusion protruding from each of the metal separators toward the resin frame member; and
a placement portion including a seal placement surface on which the resin seal member is disposed, and
wherein the seal placement surface is positioned in an opposite direction, with respect to the resin frame member, compared with an end surface of the protrusion in a protruding direction.

2. The power generation cell according to claim 1,
wherein the resin seal member includes:
a first resin seal member disposed on a first seal placement surface serving as the seal placement surface of one of the metal separators; and
a second resin seal member disposed on a second seal placement surface serving as the seal placement surface of the other of the metal separators, and
wherein the first seal placement surface and the second seal placement surface are shifted in the flow direction so as not to overlap with each other when viewed in the thickness direction.

3. The power generation cell according to claim 2,
wherein the first resin seal member includes:
a first passage seal surrounding the fluid passage; and
a first flow field seal surrounding the fluid flow field of the one of the metal separators,
wherein the second resin seal member includes:
a second passage seal surrounding the fluid passage; and
a second flow field seal surrounding the fluid flow field of the other of the metal separators,
wherein the second seal placement surface includes:
an outer seal placement surface positioned outward of the first seal placement surface; and
an inner seal placement surface positioned inward of the first seal placement surface, and
wherein the second passage seal is disposed on the outer seal placement surface, and
the second flow field seal is disposed on the inner seal placement surface.

4. The power generation cell according to claim 1, wherein the seal placement surface is formed flat and is flush with a front surface of the metal separator that faces the resin frame member.

5. A fuel cell stack wherein the power generation cell according to claim 1 is provided in plural and stacked on each other.
